(19) United States
(12) Patent Application Publication
(10) Pub. No.: US 2008/0262819 A1
(43) Pub. Date: Oct. 23, 2008

(54) Programmable Logic Array for Schedule-Controlled Processing

(76) Inventor: Jean Paul Petrolli, Antony (FR)

Correspondence Address: EGBERT LAW OFFICES, 412 MAIN STREET, 7TH FLOOR, HOUSTON, TX, 77002, US

(21) Appl. No.: 10/585,696

(22) PCT Filed: Mar. 7, 2005
(86) PCT No.: PCT/FR05/00529

§ 371 Date: May 18, 2008

(30) Foreign Application Priority Data
Mar. 8, 2004 (FR) 0402419

(51) Int. Cl. G06F 17/50

(52) U.S. Cl. 703/16

(57) ABSTRACT

The electronic data processing circuit targets the emulation of a logic function. The circuit includes a single clock providing time unit signals, a programmable synchronous logic array for processing values on a time unit basis, detection of internal or external value state changes known as events, programmer for state changes or event signals, processor for a series of scheduled times providing the logic array with scheduled time signals depending on the signals from the detection or the event programmer and the signals from the clock. The processor can determine subsequent scheduled times having delayed deadlines programmed by the programmer, depending on the signals from the detection or the programmer. The processing performed by the logic array is thus dependent on the series of scheduled times triggered by internal or external value state changes and by determination of the series of scheduled times.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a programmable logic array with processing facilities relying on a scheduler. It applies to a complex logic function emulation device triggered by an internal or external event.

### BACKGROUND OF THE INVENTION

Inside the state of art for programmable arrays, the logical function to be emulated is divided into elementary logic functions. An interconnection array made of programmable links connects the overall whole of cells in order to propagate any change of logic state towards the concerned elementary functions.

The programming of this kind of array is static (static array). The programming remains unchanged while the complex function is running.

The programming is generally the result of the placer and router software, with the support of the logic synthesizer tools to make user programming easier.

This kind of programmable array has the following disadvantages:
it does not make any distinction between the frequently activated parts and the less frequently activated parts;
it controls, with difficulty, the timing of the state change of the node, indeed it is complex and hardly predictive;
it needs a complex flow of tools: logic synthesizer, mapper and router, being expensive in the design phase;
it makes access to internal nodes difficult (consulting and modifying) otherwise than by re-programming the device;
it generates problems of excessive load of the line;
it generates operating problems in case of several clocks; and
it provides many inactivated resources with leakage current which results in significant useless power consumption for all of the circuit.

The present invention attempts to bypass these drawbacks.

The present invention targets a data processing integrated circuit intended to emulate a logic function, made of:
a single clock providing signals which are representative of time units;
a synchronous logic array processing data per time unit;
a state change detection of internal or external values, said <<events>>;
a means of programming signals of state change or of the aforesaid events;
a programming resource of signal change the said events; and
a resource of scheduling representative signals providing, to the logic array, representative signals according signals from the detection of values or the programming means of the events and the signals provided by the clock. The processing means define schedule times, at the programmed delay by the programming means, happening from functions of the signals provided by the means of detection or the means of programming. The process is made by the logic array thus being the consequences of successive schedule times triggered by state changes of internal or external values, and by one of successive schedule time determinations.

The object of this invention is an integrated device to resolve some problems that are known and that the programmable logic array cannot resolve. These problems include:
the device assigning as many resources for logic functions to emulate that they have less time requested, wherein a relation resources/time exists for each logic function;
the control of the time for re-evaluation of the state node change is under control of a scheduler, easily programmable by the user;
in some cases, the array can emulate fast functions, with higher performances than classical arrays;
the basic work of the device is synchronous of one clock and allows the emulation of one function with several clocks without any re-synchronisation problem; and
the device can control the power consumption better than a classical logic array thanks to the simultaneous logic change scheduling ability.

Thus the electronic circuit provides the commands as follows:
events combined between themselves; and
a scheduling as decided by the user.

### BRIEF SUMMARY OF THE INVENTION

According particular features, the logic array supports a logic simulator able to be integrated in an electronic circuit. The clock defines time units used for reproducing the operation of the simulator.

Thanks to these facilities:
the unit time control avoids the emulation of a delay or additional clock and makes easier the design of the function to emulate;
the time unit control offers to the designer an exact time model, within a time unit, of the function being emulated; and
the synchronous aspect avoids re-synchronization needs between asynchronous clocks in the classical array case.

According to particular features, the logic array is able to emulate a logical function without any logic element configuration.

Thanks to these facilities:
while the circuit is in operation, the basic access to the nodes for external consultation or change is easy and without re-programming; and
the flow chart, without placement and routing constraints, is simpler to design and implement.

According to particular features, the logic array consists of internal cells for logic processing and internal cells for communication with the external environment of the electronic circuit. The signals provided by the scheduler ensure the operation of at least one designated internal cell with one designated peripheral cell.

Thanks to these particular features the line overload problems are unknown.

According to particular features, designated cells transmit data by means of a unique line grouping per time unit. The designated cells are tuned to generate signals, random or programmed events, towards the scheduler. The scheduler processing means provides each cell with a control group.

Thanks to these capabilities, reading or modifying future scheduled times is possible while the circuit is running.

According to particular features, the internal processing cells are adapted to process one logic word per time unit.

Thanks to these facilities, the circuit reduces the word processing to one time unit.

According to particular features, the internal logic cells are adapted to merge several data groups coming from several respective entities and then to memorize each merged logic word.

Thanks to these facilities, the time relationship between the data processing is simpler to design and manage.

According to particular features, the peripheral cells are adapted to sample the logic word received from the environment of the circuit and to generate the merged logic words according to the communication direction.

According to particular features, the logic array possesses a specific mean of communication with the environment of the circuit. The logic array implements memorized logic words adapted to be read or modified by the specific communication means.

Thanks to these facilities, the memory access allows the generation of chronograms relative to state changes of nodes, towards the outside of the circuit in order to get an internal visibility regarding the activity of the emulated function. This is performed during or after operation, which would be difficult to realize with classical logic arrays.

According to particular features, the electronic circuit, such as succinctly presented here above, is adapted to implement a scheduler which does not need any schedule processing except delays provided by a register array and a time conflict detection between events.

According to particular features, the designated communication mean is adapted to implement a read or change of events.

According to particular features, the electronic circuit such as succinctly presented here above is adapted to implement a logic combination of data output of internal and peripheral cells at the communication time.

According to a second aspect, the present invention targets a simulator which consists of an electronic circuit such as succinctly exposed above.

According to a second aspect, the present invention targets an emulator which consists of an electronic circuit such as exposed above.

The advantages, goals and particular features of this simulator and this emulator being similar to the electronic circuit succinctly described above, are not reminded here.

### BRIEF DESCRIPTION OF THE SEVERAL VIEWS OF THE DRAWINGS

Other advantages, goals and features of the present invention will result from the description of one particular mode of realization, which will now be presented. This will be done in an explanatory objective and without any limitation with regard to the following pictures.

FIG. 1 represents a schematic view of a simplified architecture of the electronic circuit object of the present invention.

FIG. 2 represents a schematic view of a scheduler of the shown architecture in FIG. 1.

FIG. 3 represents a schematic view of a part of the scheduler shown in FIG. 2.

FIG. 4 represents a schematic view of another part of the scheduler shown in FIG. 2.

FIG. 5 represents a schematic view of still another part of the scheduler shown in FIG. 2.

FIG. 6 represents a schematic view of another part of the scheduler shown in FIG. 2.

FIG. 7 represents a schematic view of an internal memorization and processing cell (IMPC), shown in FIG. 1.

FIG. 8 represents a schematic view of an input connection cell shown in FIG. 7.

FIG. 9 represents a schematic view of a processing connection cell shown in FIG. 7.

FIG. 10 represents a schematic view of an instruction memory shown in FIG. 7.

FIG. 11 represents a schematic view of an instruction memory shown in FIG. 10.

FIG. 12 represents a schematic view of a processing cell shown in FIG. 10.

FIG. 13 represents a schematic view of a logic cell shown in FIG. 10.

FIG. 14 represents a schematic view of the architecture of the peripheral communication cell (PCC).

FIG. 15 represents a schematic view of an input output cell (IOC) shown in FIG. 14.

FIG. 16 represents a schematic view of a connecting data array.

FIG. 17 shows a schematic view of the functional loop.

FIG. 18 represents a schematic view of an event and control connection.

### DETAILED DESCRIPTION OF THE INVENTION

Before describing the figures, a general description of the electronic circuit, including the object of the present invention, is given in several parts:
a scheduler which is the core;
an N_IMPC array: Internal Memorization and Processing Cell;
a N_PCC array: Peripheral Communication Cell;
a connecting values link array between cells;
a loading dedicated cell part at the programming time called Central Programming Resource CPR; and
a reading and modifying dedicated part for stored data in IMPC, and PCC is called Central Debugging Resource.

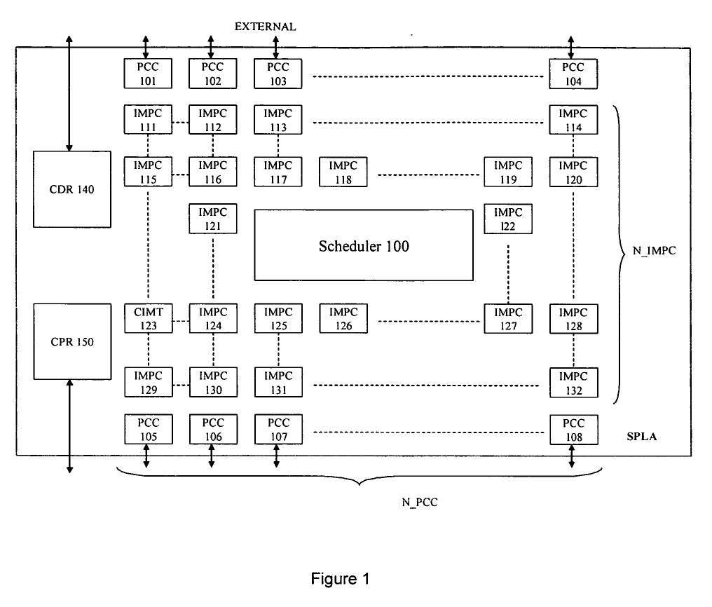

FIG. 1 describes a simplified architecture of an electronic circuit according to the present invention. Inside this architecture, a scheduler 100 has the following functions:
to accept as input the primary information of logic states changes provided by the cell IMPC 111 to 132 and PCC 101 to 108;
to combine these information to requests according to the user programming;
to schedule events as function of the user programmed delays;
to manage the compatibility between events and to re-schedule some of them; and
to provide the elementary commands for each compatible event.

In this architecture, the Internal Memorization and Processing Cells (IMPC) 110 to 132 play the following roles:
to memorize the nodes which emulate signals and variables in the emulated function;
to achieve a logic processing over these nodes; and
to generate the designated events issued from either logic processing or instruction.

In this architecture, the Peripheral Communication Cells 101 to 108 have to:
sample the externals signals;
memorize values which are converted to external signals; and
generate the events issued from changing states of the external signals.

In this architecture, the Central Debugging resource 140, in connection with an appropriate external mean, has to:
scan the nodes, instructions and scheduled times; and
modify the nodes, instructions and scheduled times.

In this architecture, the Central Programming Resource CPR 150 must set the whole of programmed cells before the running of the array.

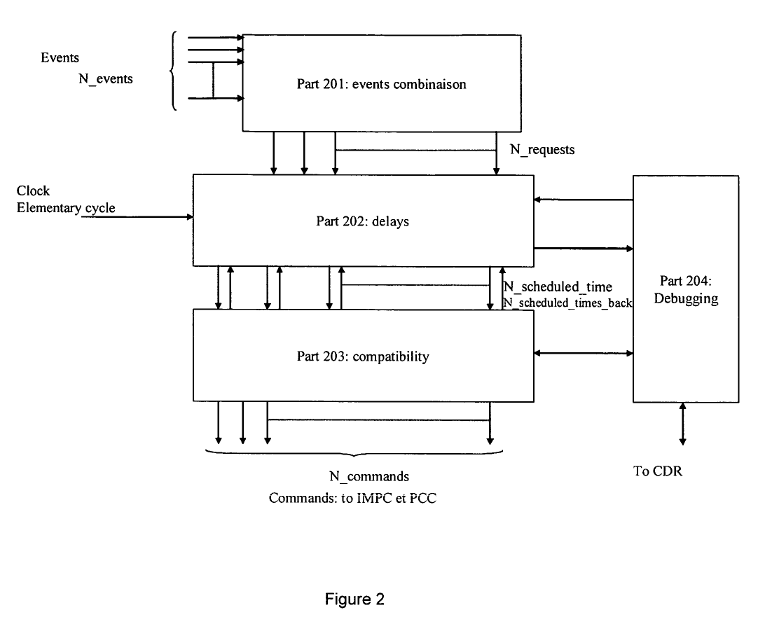

The scheduler 100 is described in FIG. 2. The part 201 (grouping) of the scheduler 100 receives an event group issued from IMPC or PCC. Each line of this group is affected to a precise type of event issued form an IMPC or a PCC.

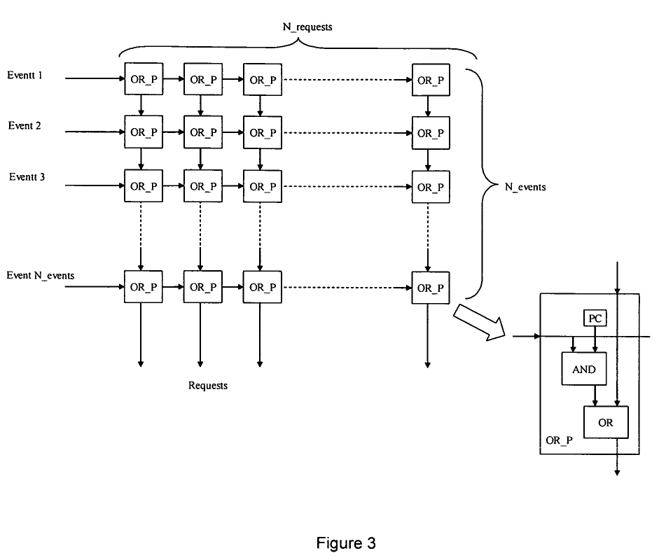

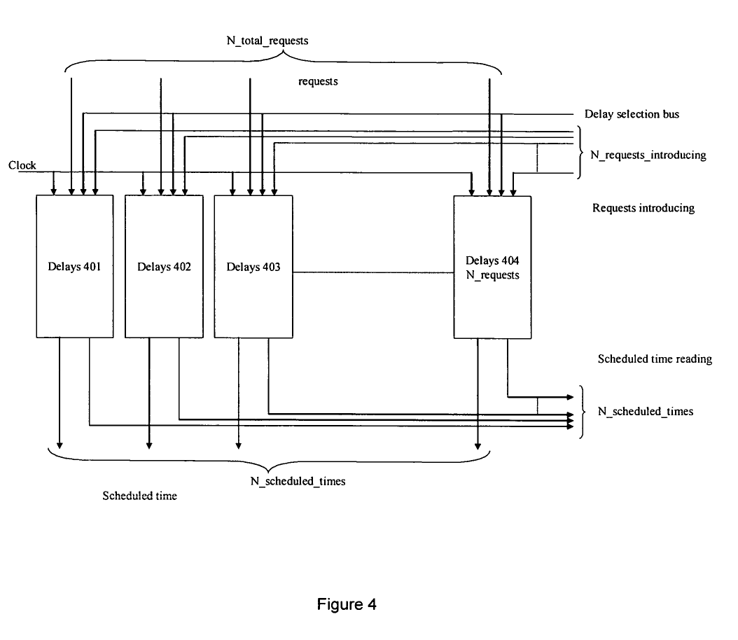

The part 201 is shown in FIG. 3. The programmed cells (PC) set the logic operations into request with an OR gates base. The request is thus activated as soon as a selected event changes to 1. The part 202 (delays) of the scheduler 100 is shown in FIG. 4. It receives the overall of requests and generates a scheduled time group. Each of which is a propagation on a programmed delay, either from a part 201 output request, or from a driven scheduled time refused by part 203.

The delay cells 401 to 404 convert each request to elementary scheduled time after a variable delay of zero to several basic clock cycles.

Supplementary requests can come from the optional debugging resource.

FIG. 4 shows the part 202 under delay cells form. At the output of the delay cells, a pack of scheduled times is generated at each time unit. The delay cells can also be read or programmed by the debugging resource in part 204 in relation with the central debugging resource CDR 140.

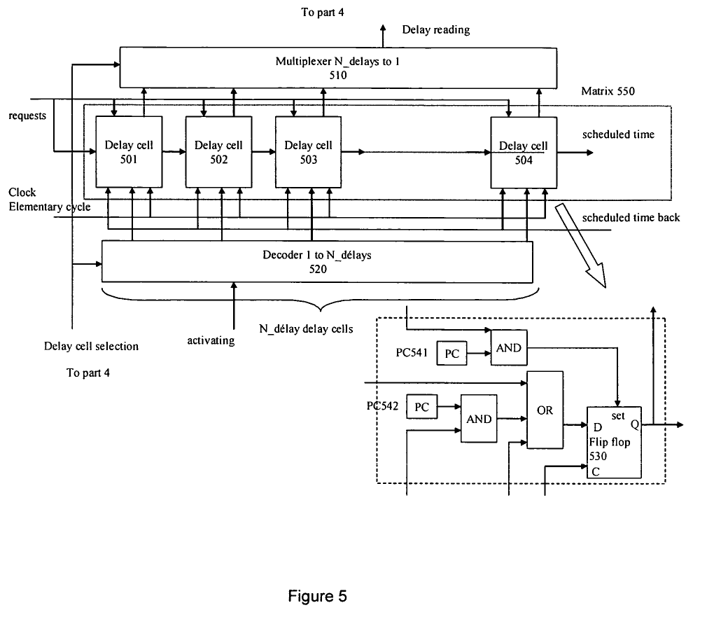

FIG. 5 describes each of the delay part 202. Each request sets immediately to 1 the flip-flop 530 according to the programming of associated cells (PC541) with the asynchronous set command of the flip-flop.

Then, the request is transmitted from one to the following flip-flops at the clock rhythm in order to reach a user desired clock cycle number for getting an event.

Matrix 550 is sized for a variable delay from 0 to as many basic cycles as cells.

Each cell can also receive a scheduled time rejected by the part 203 according to the setting of the programmed cell PC542.

Furthermore it can be set to one by the debugging resource in part 204.

The part 203 (compatibility) is used to manage priorities in case of access conflict to resources by generating new events through feedback.

This part consists of a cell array programmed by PC which:
enables or disables each action for avoiding conflict; and
sends back one or several scheduled times to reiterate actions which are impossible at the current time unit.

The conflicts in question concern the commands which will use the same resources within the same time unit.

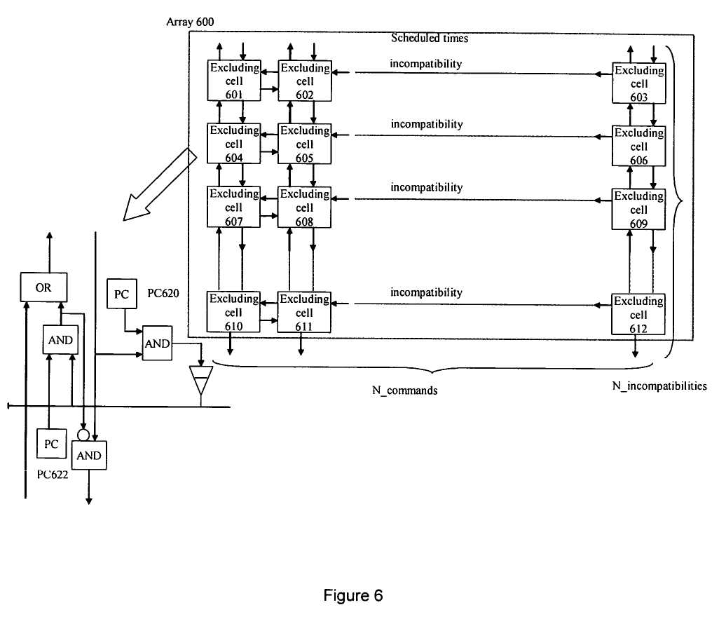

FIG. 6 shows the part 203.

The array 600 is made of one matrix of cells 601 to 612. Each of them selects (PC620) a scheduled time on the horizontal line which realizes a wired AND. The result represents an incompatibility between events within the same time unit (or basic cycle).

The cell sends back, if programmed (PC622), the result into the scheduler for generating a new delayed event and remove the current one.

The recycling of events must be perfectly controlled by the programming flow and accepted by the user.

The part 203 can process as many incompatibilities as cells lines in the array 600.

The optional part 204 (debugging) is able to read or to set each flip-flop of the scheduler, in connection with the CDR. It consists of one decoder which selects the register group according to the CDR bus, which reads, sets or resets each register of the group. Thus the user can activate or predict the current requests in a debugging procedure by the mean of the CDR.

The scheduler works with a frequency supplied by an external or internal signal. The cycle time represents the elementary time the user will must take as reference for programming the circuit.

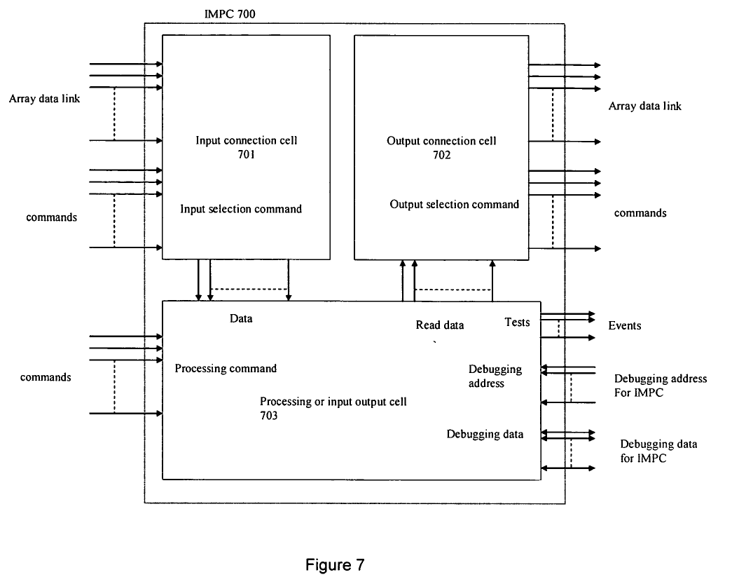

FIG. 7 shows an internal memorization and processing cell (IMPC).

The cell IMPC 700 is divided in three parts:
an input connecting cell for sending data from the general network to the processing unit 701;
an output connecting cell for sending data to the general network, the output data 702; and
a processing cell for memorizing, setting and detecting state changes 703.

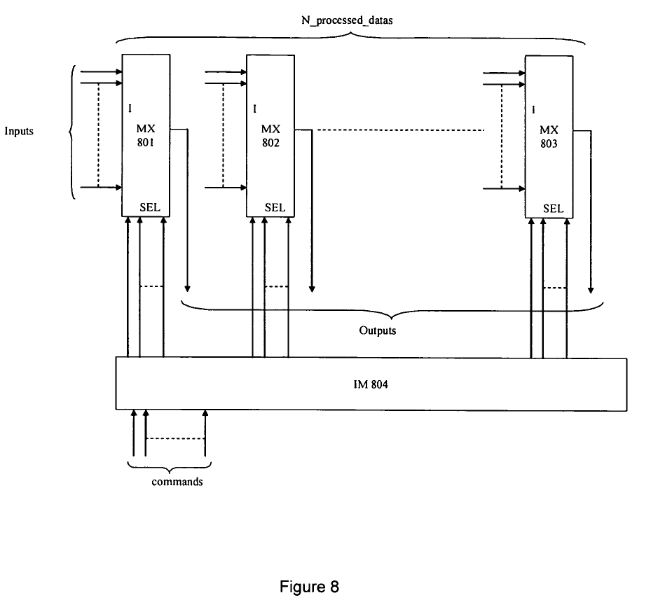

FIG. 8 describes the input connecting cell. This cell selects one line among all input lines following the instruction provided by IM 804. The elements MX 801 to 804 are simple multiplexers. The IM 804 is described below. It converts a group of commands issued from the scheduler into an instruction.

Globally, the cell is able to take randomly an input line and report it to the output according to the instruction selected by commands.

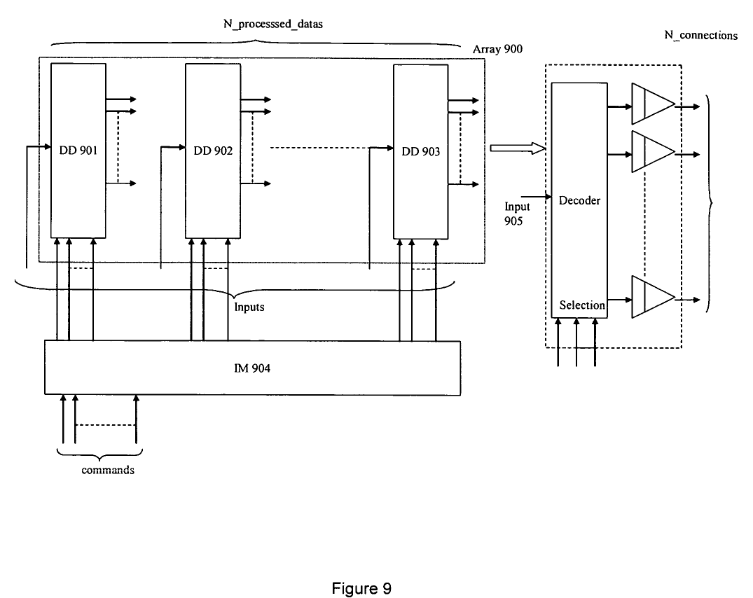

FIG. 9 describes the output connecting cell. The array 900 activates, from each of the input lines, an open collector gate with as many outputs as inputs.

The general data line 905 which is connected, makes a wired OR with the other cells.

The operating mode is identical to that of the connecting input cell.

Globally, the cell is able to assign randomly each input line on each open collector output following the instruction selected by commands.

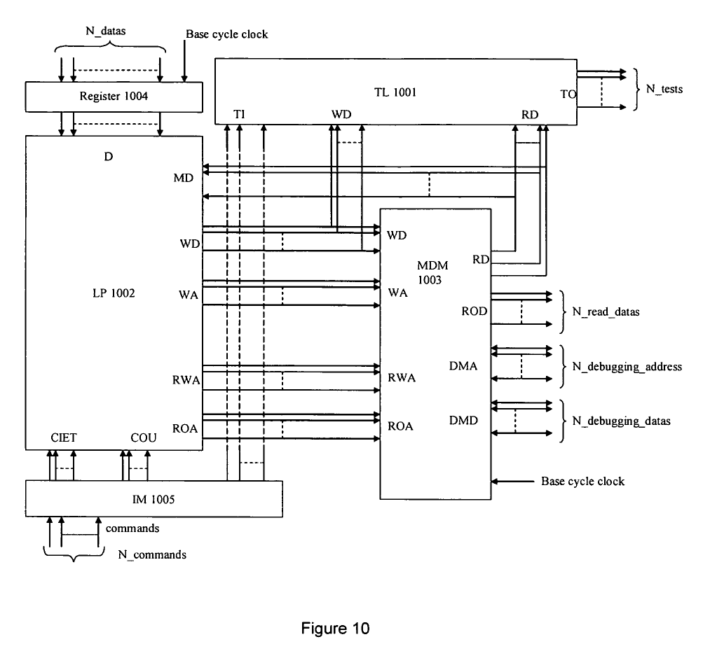

FIG. 10 describes the processing cell, which must:
memorize logic words;
execute logic operations between internal memorized values and external values;
provide the outside with memorized logic words; and
report to the outside changing values.

The processing cell is divided into four parts:
an instruction cell IM 1005 which generates an instruction from scheduler commands;
a logic processing cell LP 1002 which executes the logical operations, chosen by the instruction, on the data issued from the input connection cell and the memorized data in the memory MDM 1003;
a test logic TL 1001 which must detect the state changing under several forms and must generate events to the scheduler 100; and
a multiple access memory.

The multiple access memory:
writes and reads access: RWA, written data WD and read RD, written authorization WA;
reads read only access: address ROA, data ROD; and reads optional debugging read and write access: debugging memory address DMA, debugging memory data DMD.

The cell receives directly a part of actions from the scheduler. These are combined between themselves, within the instruction memory IM 1005, by means of AND operators to form a selection group. Each selection is activated by the simultaneous presence of one or several commands.

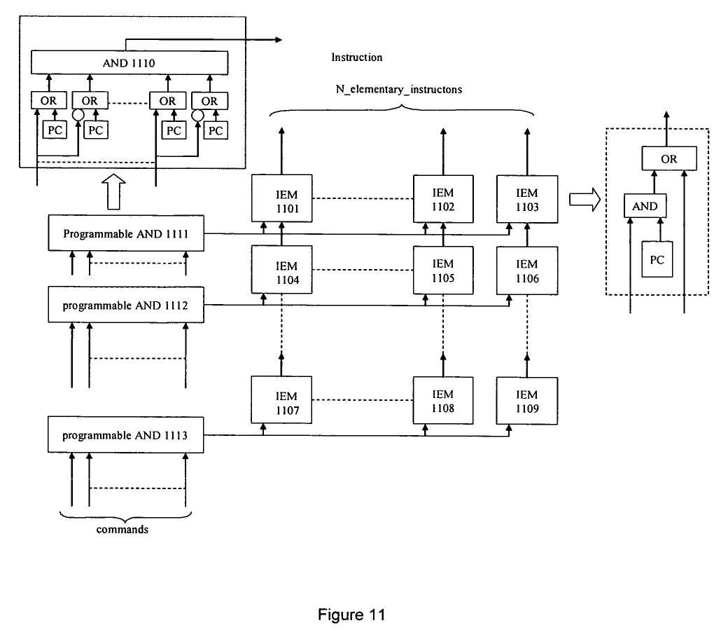

FIG. 11 describes the instruction memory. The interest of selecting one combination is to activate a selection either:
by the obligatory presence of several scheduled times; or
by a particular combination of commands which forms a word.

Each selection addresses a programmed instruction in programmed cells of IEM 1101 to 1109. The resulting instruction is an OR between the programmed instructions. The instruction memory IEM 1005 is programmed by means of the Central Programming Resource CPR.

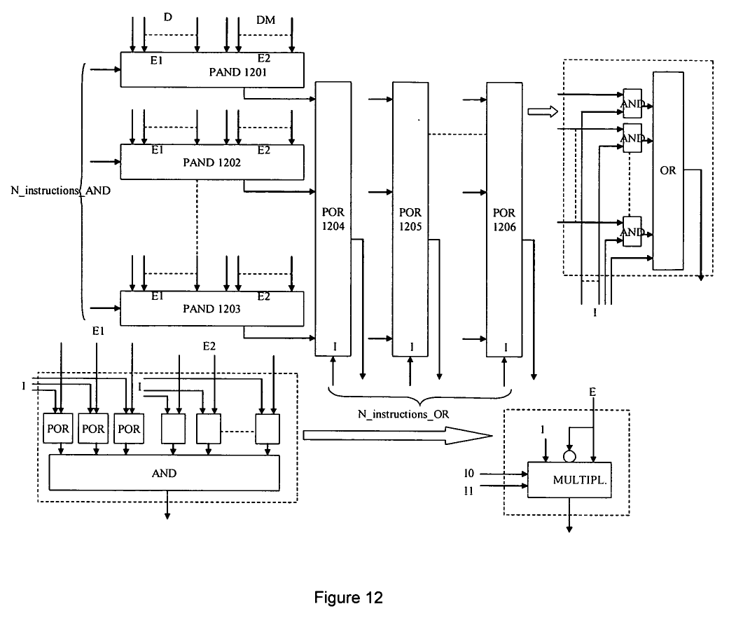

FIG. 12 describes the logic processing cell LPC 1002. The operators PAND 1201 to 1203 are programmable AND which do the AND between the input E1 and the input E2 with or without inversion. The operators POR 1204 to 1206 are programmable OR which do the OR with all PAND outputs for only one output by operator. The POR have one a command which sets the output to one. The number of PAND and POR defines the flexibility and the range of applicable operations in the same time.

The logic processing cell LPC provides:
the predefined or computed address of the new data to memorize and its content;
the computed or predefined data to memorize;
the enable write commands by bit of data to memorize; and
the predefined or computed address of data to read for the other processing cells through the output connecting cell.

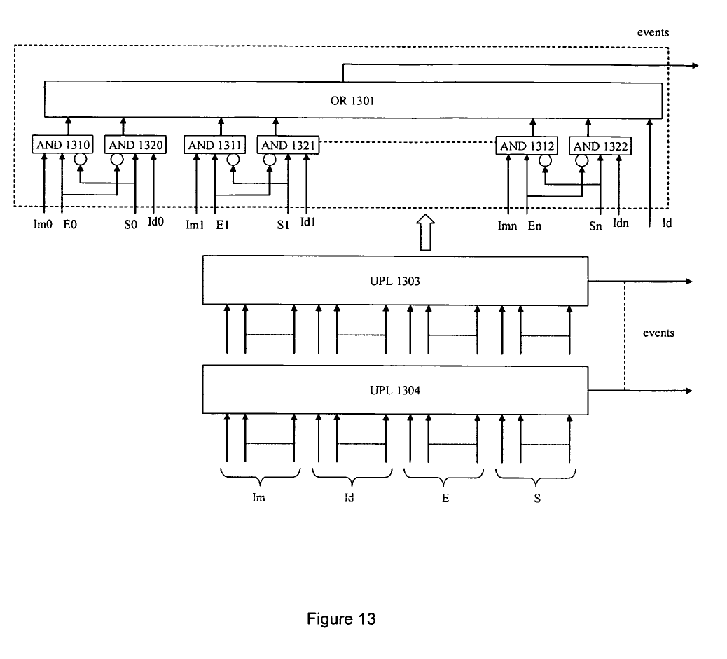

FIG. 13 describes the unitary test logic cell formed by a group of UTL 1303 to 1304 belonging to an output event. Each UTL is an OR between outputs, validated or not through an instruction:
of AND 1310 to 1312 between inputs and the inverted outputs validated by the instruction Ir0 to Irn: value change detection 0 to 1; and
of AND 1320 to 1322 between the inverted input and the outputs validated by instruction if0 to Ifn: value change detection 1 to 0.

Each UTL gets an instruction input which activates directly the event output.

Thus each UTL can activate an event during a rising edge, a falling edge or both of them for each binary element of one group memorized in the MEMD or directly by instruction.

The Peripheral Communication Cells with external, PCC, take charge in a group of input/output.

The cells PCC must:
receive external signals and generate the events on state change to the scheduler;
stock temporarily these signals in order to enable their reading by the other Internal Memorization and Processing Cells: 2 minimal cycle clocks; and
memorize signals to output with or without setting high impedance.

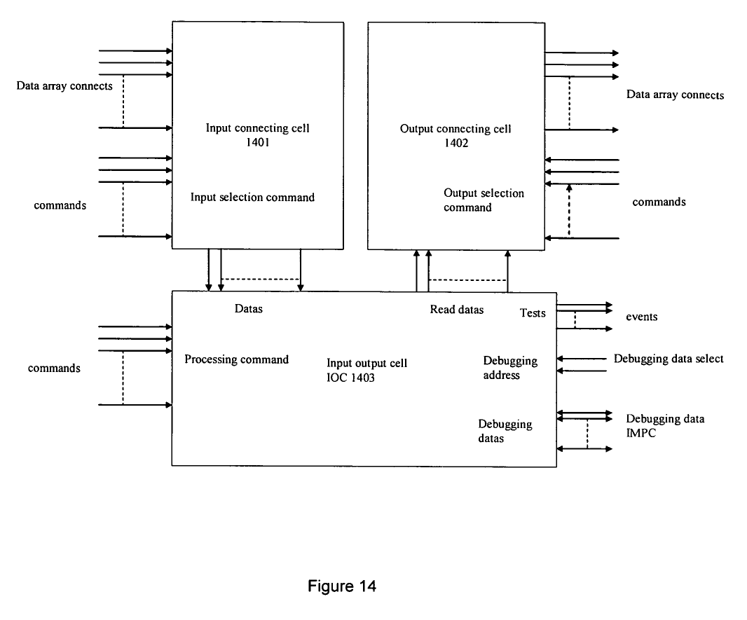

FIG. 14 shows the architecture of a PCC, divided into three cells:
connecting cell 1401 of input data identical to these of IMPC;
the connecting cell 1402 of output identical of these of the IMPC; and
the proper input output cell IOC 1403.

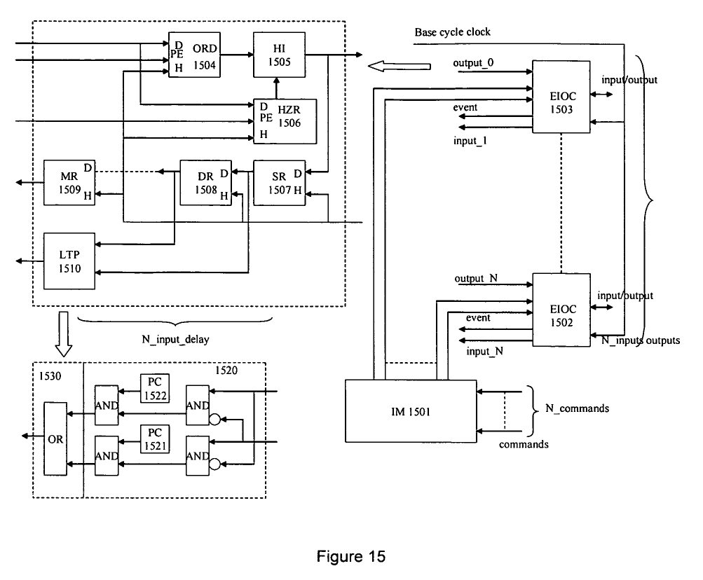

FIG. 15 describes the input output cell IOC.

The cell 1403 is a group of Elementary Input Output Cells 1502, 1503 controlled by an Instruction Memory IM identical to that of the IMPC.

The input signal part consists of:
a first synchronization register SR 1507 which synchronizes with respect to the basic cycle;
a second Delay Register DR 1508 which delays the input for detecting any changing state;
several memorization registers MR 1509 which delay the input group for the delayed input data reading;
a Programmable Test Logic PTL 1510 programmed once which detects the changes of state between the input and the output of DR;
an Output Data Register 1504 which memorizes the output signals; and
a High impedance Control Register HZR for setting the output to high impedance of the output of the High Impedance buffer HI 1505.

For the input signals, the working is as follows:
each input signal is delayed by the SR 1507; and
a test logic 1520 activates an output on the change of the output SR 1507.

The test logic includes:
“0” to “1” if the Programmed Cell PC 1521 is in high state; and
“1” to “0” if the Programmed Cell PC 1522 is in low state.
a secondary test logic 1530 selects some of the outputs by means of an OR operator and generates separately several events to the scheduler 100 according to the programming of PC: PC 1521 for the rising edge and PC 1522 for the falling edge on the input of the programmable circuit like in the IMPC;
these inputs are then delayed in Memorization Registers MR 1509 in order that they can be read by other IMPC or PCC; and
the output registers and high impedance registers are set by the Instruction Memory IM 1501.

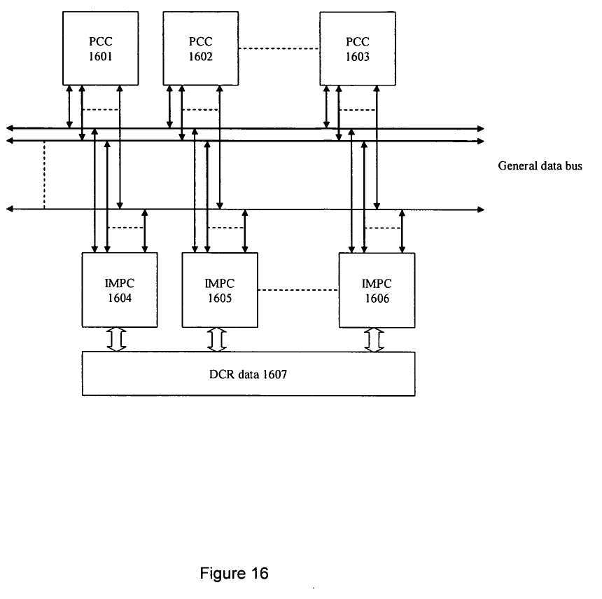

FIG. 16 describes the data connecting array which has to link all data connecting cells of the Internal Memorization and Processing Cell IMPC 1604 to 1606 with the Peripheral Communication Cell PCC 1601 to 1603 so that there is exchange of data at each time unit.

The whole of instruction Memories IM of connecting cells must make these exchanges compatible by using only one resource per time unit.

The programming means must be bound by this obligation before configuring any exchange. The optional Central Debugging Resource CPR 1607 reads or sets data through external means while the circuit is running.

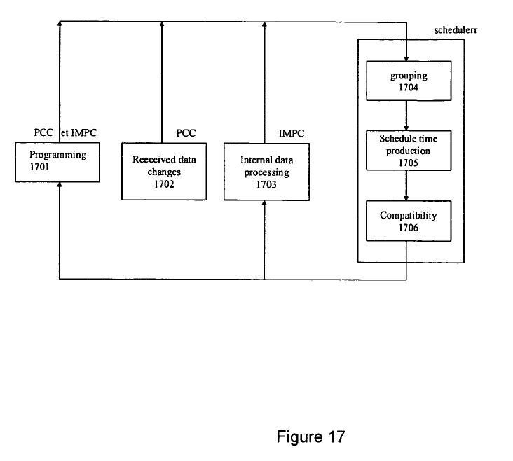

FIG. 17 schematizes the operating loop which symbolizes the links between the events from internal changing states (IMPC) or external ones (PCC), or programmed and the commands.

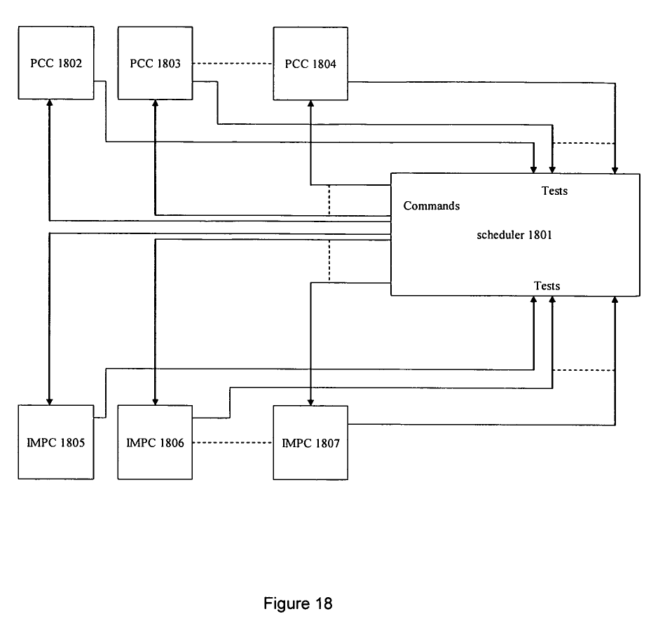

FIG. 18 describes the connection events commands. The cells input output PCC and the processing cells IMPC generate events to the scheduler. This one transforms these events into scheduled times then into commands to the PCC or IMPC. The operation scheduling part works on this principle in a closed loop.

The event generation is either:
determined by the instructions and thus by programming; or
triggered by data state changes processed by the IMPC or received by the PCC.

The command generation and instruction programming respects the resource mapping without conflict.

The working of the circuit is described below as shown in FIGS. 1 to 18. The logic array is in principle connected to other digital circuits which activate the inputs of PCC and receive the outputs of PCC.

Once power is on, the circuit reads configuration data for setting the all of the PC.

The loading method uses the classical ones and is not the subject of whatever claims in the present invention.

The logic array will thus operate with two kinds of events:
timed-programmed events within the emulated function (for instance clock signals); and
random events caused by the external or internal changing state events of logic array.

As soon as an input changes state, the test logic LT of the concerned PCC transmits this change, as an event form, to the scheduler.

The scheduler initiates a stream of actions which are going to induce in their turn changes of internal states within IMPC or external in PCC.

Furthermore, the scheduler starts autonomously periodic or not periodic actions which let the identical effects as random events.

The whole of the array is cadenced by a unique clock which represents the elementary simulation time of the emulated function.

The programming data elaboration is described below.

The elaboration is done in narrow relation with a logical simulator.

The programming flow can be reduced into a compiler from one or several source files.

This compiler generates both the programming data for the array and the modified source file within the possibilities of the array.

If the source file is replaced by the modified version from the compiler, this one:
maintains this version without programmer operation; and
uses the version modified by the programmer.

The programmer knows exactly the operation of the emulated function since the logic array reproduces the operation of the simulator which is being used to validate, within one time unit.

The source program lists a group of actions conditioned or not but activated by external or internal events with the delay time specification.

The presence of simultaneous and incompatible actions is treated by the compatibility manager of the scheduler which gives the priority to some actions over others.

Actions which cannot be taken into account due to incompatibility are delayed or cancelled under control of programming.

The compiler must integrate these delays or cancelling of actions.

The loading is described below.

The initial loading consists of decoding external programming data issued of classical means (memory or external loading mean) and to set all the programmed cells PC.

The dynamic operation is described below.

The logic array is running with a unique internal or external clock time, the clock cycle defines the time unit for the logic function to be simulated.

In absence of external events, the scheduler generates actions from this part 3 (see FIGS. 2 and 6).

These actions activate the instructions in PCC and IMPC cells.

The presence of external events generates also events through the PCC.

The optional debugging functions in connection with classical resources JTAG (Join Test Action Group) or specific bus, are able to:
read an internal variable and to publish its internal state to the outside;
report the evolution of an internal variable as a function of time;
act on an internal variable;
read the scheduler state: action flow; and
add a processing instruction.

I claim:

1. Electronic circuit of data processing to emulate a logic function, the circuit comprising:
a single clock providing representative signals of a time unit;
a synchronous programmable logic array processing values per time unit;
a means of state change detection, designating events as internal or external values;
a means of programming signals for changing state or directly programming the events; and
a means of successive scheduled times processing providing a logic array with representative scheduled time signals according to the signals provided by the means of state change detection or by the means of programming signals or the events, the processing mean being adapted to determine scheduled times, at time delays by programming the programming means, a function to happen being provided with signals by the means of detection; wherein processed operations done by the logic array result from successive scheduled times initiated by internal or external state changes and a successive scheduled time determination.

2. Electronic circuit according to the claim 1, wherein the logic array reproduces a simulator operation integrated into an electronic circuit, a clock defining time unit being tuned for reproduction of the simulator.

3. Electronic circuit according to the claim 1, wherein the logic array is able to emulate, at real time, a logic function without any logic element emulation.

4. Electronic circuit according to claim 1, wherein the logic array is comprised of internal logic processing cells and peripheral communication cells with the outside of the electronic circuit, the signals provided by the scheduled time processing controlling the operation through at least one internal cell or one peripheral cell.

5. Electronic circuit according the claim 4, wherein the cells exchange data through one single group of lines on which is set up an exchange per time unit, the cells being adapted to generate signals, random or programmed events, towards the scheduled time processing unit, the means of processing scheduled time providing to each cell a command group.

6. Electronic circuit according to claim 4, wherein the cells of internal processing cells are able to process a logic word per time unit.

7. Electronic circuit according to claim 6, wherein the internal logic cells are adapted to merge several data group issued of several respective identities and to memorize each merged logic word.

8. Electronic circuit according to claim 4, wherein the peripheral cells are adapted to sample logic words received from the external of the circuit and to generate merged logic words according the communication direction.

9. Electronic circuit according to the claim 5, wherein the logic array is comprised of a specific means of communication with the outside of the circuit, the logic array setting up memorized logic words adapted to be read or modified by the specific communication mean.

10. Simulator comprising:
an electronic circuit according to claim 1.

11. Emulator comprising:
an electronic circuit according to claim 1.

12. Electronic circuit according the claim 4, further comprising:
a scheduler needing no scheduled time processing other than delays managed by a register matrix and a conflict detection between scheduled times.

13. Electronic circuit according the claim 12, wherein the specific communication means reads and changes scheduled times.

14. Electronic circuit according the claim 4, further comprising:
a logic combination of output datas formed of internal or peripheral communication cells.
